(19) United States
(12) Patent Application Publication
(10) Pub. No.: US 2013/0288096 A1
(43) Pub. Date: Oct. 31, 2013

(54) MODULAR BATTERY

(71) Applicant: GENERAL ELECTRIC COMPANY, Schenectady, NY (US)

(72) Inventors: KRISTOPHER J. FRUTSCHY, CLIFTON PARK, NY (US); JAMES LINDSEY, CLIFTON PARK, NY (US); MICHAEL ZANONI, GLENS FALLS, NY (US); LENG MAO, LATHAM, NY (US)

(21) Appl. No.: 13/927,571

(22) Filed: Jun. 26, 2013

Related U.S. Application Data
(63) Continuation-in-part of application No. 13/234,638, filed on Sep. 16, 2011.

(51) Int. Cl. H01M 2/10

(52) U.S. Cl. CPC H01M 2/1088
USPC 429/99

(57) ABSTRACT

Systems for providing assemblies for containing multi-cell battery systems, and/or multi-cell batteries using such enclosures, are described. A battery case may be partitioned into a battery management portion and a cell portion. Each portion may be configured to accept corresponding battery components in a modular fashion allowing easy installation, removal, and access. The batteries may be configured for convenient handling, storage, and use in a variety of environments.

### CROSS-REFERENCE TO RELATED APPLICATION

This application is a continuation-in-part of U.S. patent application Ser. No. 13/234,638, entitled “STRUCTURE, PACKAGING ASSEMBLY, AND COVER FOR MULTI-CELL ARRAY BATTERIES” and filed Sep. 16, 2011, the disclosure of which is incorporated herein by reference.

### BACKGROUND

1. Technical Field

Embodiments of the subject matter disclosed herein relate to energy storage devices. Other embodiments relate to packaging configurations for energy storage devices.

2. Discussion of Art

Power supply networks at least partially reliant on battery power are highly important in many parts of the world. Particularly in remote and developing areas, business, public communication, and even healthcare may rely on battery systems as a backup and part-time primary power source.

Because such critical systems depend on batteries, it is important that new batteries be commercially accessible in sufficient quantities, have an extended service life, and are capable of being repaired or maintained when portions of the batteries fail. Further, the increasing handling convenience of the batteries can benefit the flexibility of use and possible environments in which they can be integrated.

Thus, there is an ongoing need to provide high-quality batteries in cost-effective and flexible configurations.

### BRIEF DESCRIPTION

An embodiment relates to a high temperature battery comprising an inner case configured to contain one or more battery cells, at least one cell electrical connector configured to place the one or more battery cells in electrical communication, a two-compartment outer case, and an electrical interface assembly. The two-compartment outer case comprises a first compartment configured to contain at least the inner case, and a second compartment configured to contain at least a battery management system. The electrical interface assembly includes at least one bus wire configured to provide at least one connection for electrical communication between the first compartment and the second compartment.

Another embodiment relates to an assembly for enclosing a high temperature battery system. The assembly comprises a substantially cuboid cell retaining portion configured to accept a plurality of electrochemical storage cells, wherein the cell retaining portion is configured to open and close via at least a movable portion of a wall of the cell retaining portion. The assembly further comprises a battery management system retaining portion configured to accept a battery management system, wherein the battery management system retaining portion is dimensionally similar to the cell retaining portion in at least two dimensions. The assembly further comprises an electrical interface assembly configured to establish electrical communication between the cell retaining portion and the battery management system retaining portion, and an outer shell portion that is configured to enclose at least the cell retaining portion and the battery management system retaining portion.

In another embodiment, a high temperature multi-cell battery comprises an inner case configured to contain one or more battery cells, a two-compartment outer case, at least one fiberglass-core vacuum insulating panel, and an electrical interface assembly. The two-compartment outer case comprises a first compartment configured to contain at least the inner case, and a second compartment configured to contain at least a battery management system. The at least one fiberglass-core vacuum insulating panel is between the inner case and the two-compartment outer case spanning at least one face of the inner case. The electrical interface assembly includes at least a first high-temperature insulated flexible bus wire and a second high-temperature insulated flexible bus wire configured to provide at least one connection for electrical communication between the first compartment and the second compartment, wherein the first high-temperature insulated flexible bus wire is configured to be connected to a positive electrical terminal associated with the one or more battery cells, and wherein the second high-temperature insulated flexible bus wire is configured to be connected to a negative electrical terminal associated with the one or more battery cells.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Reference is made to the accompanying drawings in which particular embodiments of the innovation are illustrated as described in more detail in the description below, in which:

FIG. 1 illustrates an example of an integrated battery system including a battery management system (BMS) compartment and insulated panels;

FIGS. 2A, 2B and 2C illustrate examples of an integrated modular battery system;

FIG. 3 illustrates an example of a battery system including an integrated battery management system (BMS);

FIGS. 4A, 4B, and 4C illustrate examples of a multi-compartment integrated battery system;

FIGS. 5A, 5B, and 5C illustrate examples of a battery system including integral closing compartments for a battery cell module and a battery management system (BMS) module;

FIG. 6 illustrates an example of an integrated battery system;

FIGS. 7A and 7B illustrate examples of components included in an integral battery management system (BMS);

FIGS. 8A, 8B, and 8C illustrate perspective examples of at least an integral battery cell compartment;

FIGS. 9A and 9B illustrate examples of techniques for utilizing batteries herein in varying environments;

FIGS. 10A and 10B illustrate examples of techniques for storing and utilizing batteries herein;

FIGS. 11A, 11B, 11C, and 11D illustrate aspects for handling batteries herein;

FIGS. 12A, 12B, 12C, and 12D illustrate examples of handling hardware for batteries herein; and

FIGS. 13A and 13B illustrate examples of components for maintaining a consistent temperature gradient across a plurality of battery cells.

### DETAILED DESCRIPTION

Aspects herein relate to systems and methods providing battery systems including features that contain costs related to assembly, maintenance, transportation, storage, use, and other expenses incurred during a battery lifetime. In particular, a variety of flexible, scalable-cost features may be applied to modular batteries to accommodate a wide variety of uses.

In embodiments, an outer battery case may be a partitioned case designed to accept the various modules associated with batteries disclosed. The outer battery case may include a cell compartment that accepts an inner cell case housing a plurality of battery cells. The battery cells can be, for example, electrochemical storage cells. The cell compartment may be integrated with a common battery case accepting cell compartments of the design employed. In turn, individual cells or groups of cells may be added or removed from the cell compartment to provide flexibility with respect to removing and/or replacing damaged or degraded cells. Thus, an integrated battery as described herein may have cell cases that may be easily installed or removed as needed (e.g., if all cells are degraded but the battery case and associated battery management system are still serviceable). Further, the cell cases may have individual cells that may be easily installed or removed as needed (e.g., if a single cell is degraded or leaking but the remainder of cells are still serviceable).

The cases can have removable lids for purposes of ease of access to different components and subcomponents. An inner cell case can have a removable inner lid providing access to groups or individual battery cells when removed. The outer battery case can have a removable outer lid that, when removed, allows access to the inner cell case. In embodiments, removal of the outer lid can alternatively or also permit access to the BMS or portions thereof

In aspects herein, one or more of the cases or compartments can be substantially cuboid in shape and/or construction. Substantially cuboid shape or construction describes box-like containers with a top, bottom, and four walls. By referring to these as “substantially cuboid” rather than simply “cuboid,” it is understood that variants such as those including rounded edges, protruding or recessed features, and sides intersecting at angles greater or less than 90 degrees do not depart from the scope or spirit of the innovation. In at least one embodiment, one or more lids can be movable portions of a wall of the substantially cuboid cases or compartments. In at least one embodiment, a movable portion of a wall can include a lid atop an upright battery that rotates about a pivot or removes completely by lifting. In one or more alternative embodiments, a movable portion of a wall can be a side wall (e.g., when the battery is upright, a structural portion perpendicular to the ground) capable of opening or removal.

A partitioned battery case may also include a battery management system (BMS) compartment or BMS retaining portion. A BMS may be an electrical or electronic system that may perform functions such as monitoring the state of one or more battery components, managing discharging and recharging, protecting one or more battery components, balancing or regulating battery components, providing feedback to users or systems, and so forth. In previous batteries or battery architectures, BMSs were not easily integrated with the components of a battery. Both electrical and mechanical connections were cumbersome and subject to failure. Thus, by providing a partitioned battery case including a BMS compartment or interface, BMSs may be employed in a way that increases their durability and utility. In embodiments, the BMS retaining portion can be dimensionally similar to the battery case in two or more dimensions. As used herein, “dimensionally similar in two or more dimensions” intends for the distinct portions to align and/or fit together without significant discontinuity. For example, a BMS retaining portion that is dimensionally similar to a battery case in two or more dimensions can have the same height and width of the battery case, aligning with the face of the battery case with which the BMS retaining portion is coupled, and have a different depth as required to retain the BMS.

The BMS can include multiple subcomponents. For example, the BMS may have multiple distinct boards, layers, or component groups. In one embodiment, the BMS includes a passive component board comprising passive electrical components. The BMS may also include a logic board including active electrical components. In another alternative or complementary embodiment, the BMS can include various interfaces and other aspects connected to a front plate to allow external observation or position outwardly in the battery construction (e.g., to allow an electrical connection, to vent heat).

The BMS compartment can include an electrical interface assembly to facilitate integration of the BMS with the battery. In one embodiment, the BMS can be integrated into the battery. In this regard, integration can include more than establishing electrical communication and/or applying mechanical fasteners. Rather, a BMS (or portion thereof) can be housed within or mate with a battery case. Further, the BMS can be integrated in a fashion that facilitates airflow through or around the BMS, and between portions of the case with which the BMS is integrated and other areas of the system. In one embodiment, an electrical configuration assembly can include a slot or other specifically- designed holes or apertures to direct components between compartments of a battery case. For example, bus wires, sensors (e.g., temperature sensing wires, voltage sensing wires), heating wires, and others can pass between a BMS compartment and a cell compartment through at least a portion of the electrical interface assembly.

Insulating panels may be employed at various portions in a battery to optimize the battery's function and longevity. For example, an optimal cell running temperature may be determined during the cells' discharge and/or charge, meaning thermal isolation from other components (e.g., a BMS) may facilitate improved battery performance. In another example, battery components (e.g., a BMS) may generate heat that must be contained or dispersed to avoid increasing the temperature of components not intended to bear such. To accomplish such ends, insulating panels may be used around or between components.

A relatively inexpensive insulating panel may be a vacuum insulated panel (VIP). In one embodiment, VIPs may be used to thermally insulate or isolate one or more battery components. A VIP may include, for example, a fiberglass core in a vacuum-sealed metal skin. Such VIP configurations may be less expensive than alternative insulating materials such as fumed silica. A VIP can be, for example, a core panel surrounded by a stainless steel skin that has had vacuum suction applied within the skin before sealing around the core.

In addition, thermally conductive components may be used in batteries. In an example, it may be desirable to maintain a uniform temperature gradient across a plurality of battery cells. In this way, conductive thermal components may travel in spaces between cells to allow higher-temperature areas to more rapidly transmit thermal energy to lower-temperature areas. In an embodiment, a plate may traverse one or more sides of a plurality of battery cells to “spread” a thermal load across the plane(s) covered. In another embodiment, a serpentine may travel between a plurality of battery cells to “spread” a thermal load between batteries. One or more embodiments may be used independently or in conjunction with one another.

Another example of thermally conductive components may be a heat sink. A BMS, for example, may employ a heat sink. In one embodiment, a heat sink may include a plurality of fins intended to facilitate airflow over a surface area (e.g., that is larger than would be available with a two-dimensional plane) to diffuse heat from one or more components or subcomponents that generate excess heat.

As used herein, “high temperature” refers to temperatures at which the cells of sodium-β (e.g., sodium-nickel) or molten salt batteries operate. In embodiments, high temperature batteries can include cells that operate at or above 150° C. In additional embodiments, high temperature batteries can operate at or above 400° C. In still further embodiments, high temperature batteries can operate at or above 700° C.

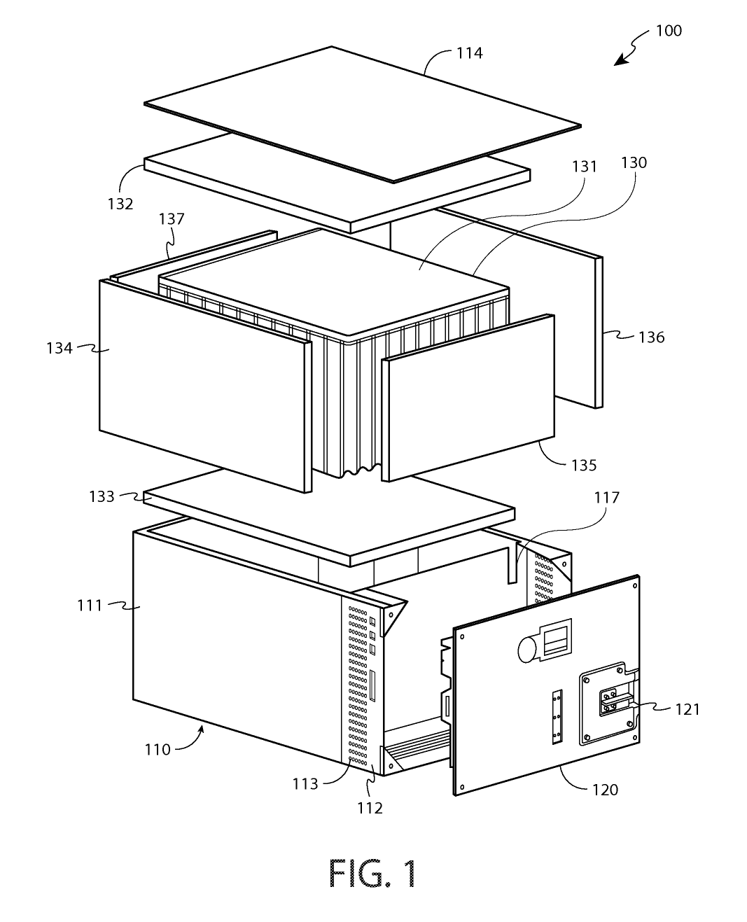

Turning now to FIG. 1, illustrated is an exploded view of an embodiment of an integrated battery system 100 including a battery management system (BMS) compartment 112 and insulated panels 132-137. The system may include a battery case 110 that is partitioned to include a cell compartment 111 and the BMS compartment.

The BMS compartment may house BMS 120. The BMS compartment may further include BMS vents 113 to allow airflow through and around the BMS. The BMS may include user electrical connection 121 to allow coupling with a load, DC bus, external system, or other connection to which a battery is applied.

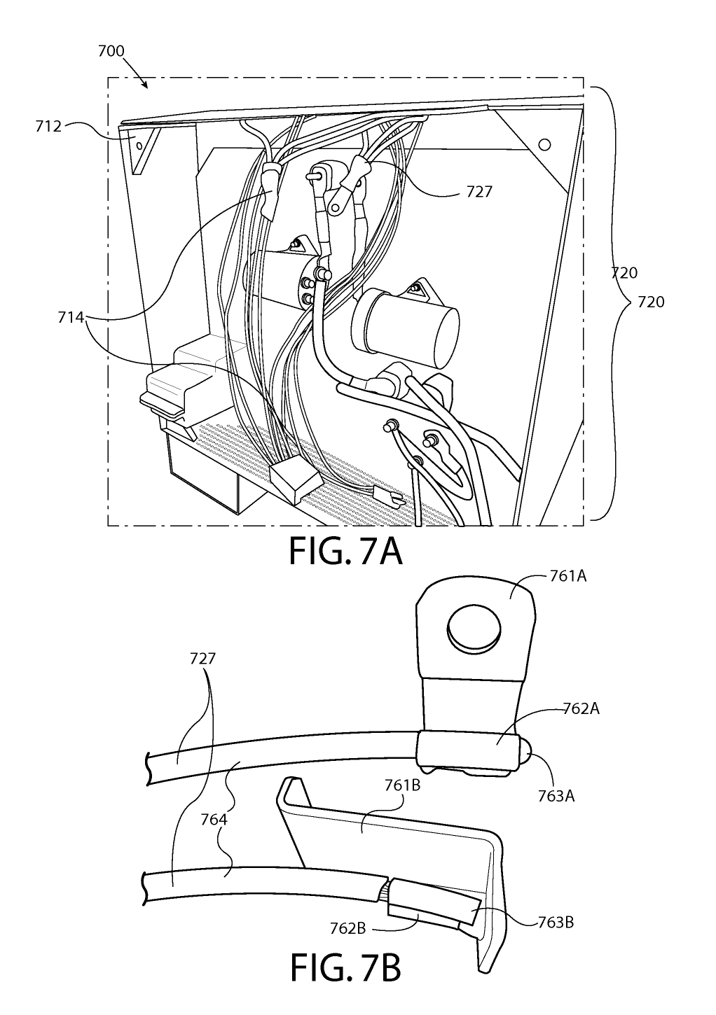

The BMS compartment may include electrical feedthrough 117 from the cell compartment to the BMS compartment. For example, bus wires (e.g., as in FIG. 7) may be employed to provide an electrical connection between the cell compartment and the BMS compartment.

The BMS compartment may be configured in a plurality of ways, such as illustrated in the example system where a BMS is retained and/or affixed to gussets 112A extending from the corner structure of the BMS compartment (and larger battery case) to retain a BMS. In an embodiment, the BMS can be attached to the gussets or other portions using fasteners. In an alternative or complementary embodiment, the BMS may be configured to integrate without the use of fasteners (e.g., close-fit, retaining members built into the BMS compartment, slide-in retained by a lid, closing or locking portions, and others).

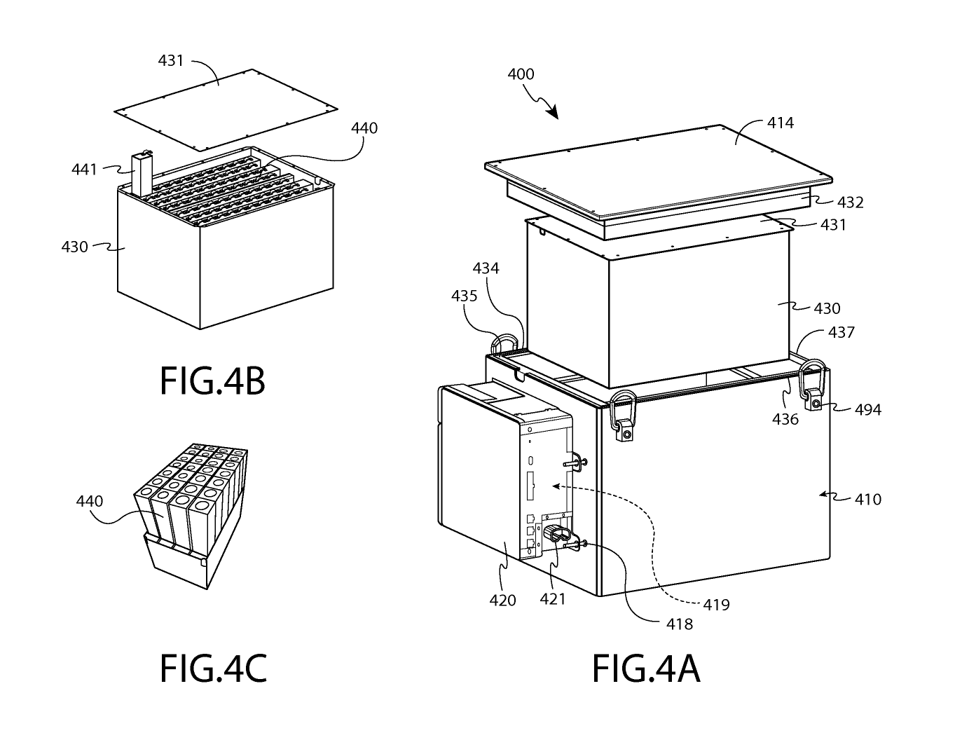

In a further alternative or complementary embodiment, a BMS mechanical interface may be provided that does not include a BMS compartment (e.g., as in FIG. 4).

The battery case may further include removable lid 114. Removable lid 114 may cover and/or enclose one or both of the cell compartment and the BMS compartment. By using the removable lid, one or more modular portions of the system may be both securely retained and easily accessed.

The cell compartment may accept cell case 130. The cell case may include battery cells. In one embodiment, cells may be added or removed from the cell case individually or in groups. To facilitate modularity, access, and robustness, the cell case may include cell case lid 131 which may be installed or removed to contain or reach battery cells.

Within the cell compartment, the cell case may be surrounded by the insulating panels. The insulating panels may be, for example, vacuum insulated panels. In one embodiment, vacuum insulated panels may include a fiberglass core. Such vacuum insulating panels have a low material cost and modest labor and tooling costs. They provide excellent resistance to heat loss and high mechanical stability compared to alternatives.

The system may thus include an integrated, modular battery configuration that allows access, swapping, and/or reuse of battery components. The BMS may be easily removed and replaced with another if unserviceable (e.g., damage to logic board), and removal or replacement is scalable to allow access and management of particular components or sub-components without complete disassembly of the battery. Alternatively, the BMS may be easily removed and replaced to another system if other portions of the battery become unserviceable (e.g., cell compartment punctured by forklift). Thus, rather than scrapping an entire battery due to an unserviceable portion, batteries may be maintained in the field, and individual components may be replaced.

In addition, the integrated, modular arrangement facilitates uniform geometries and robust connections. For example, by including a BMS compartment, the BMS may be flush-connected into the battery to avoid or resist damage to which other configurations are vulnerable. Through use of improved bus wires and electrical feedthroughs, high performance may be delivered in a sturdy, uniform, and singular structure.

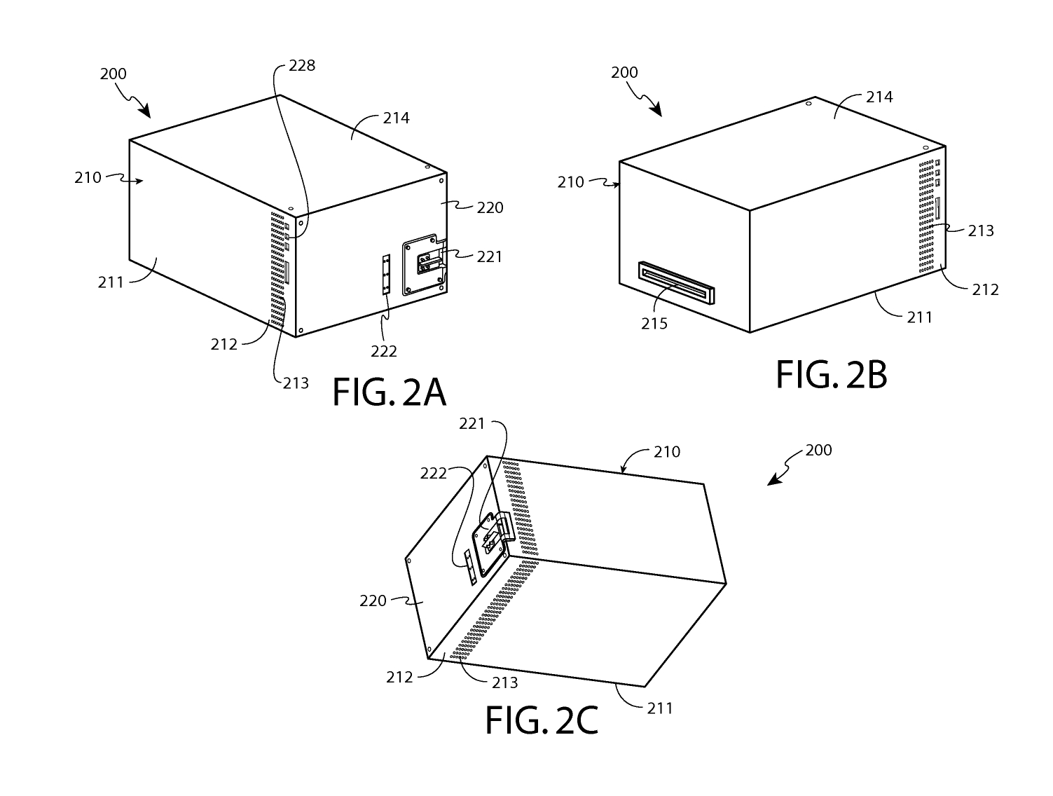

FIGS. 2A, 2B and 2C illustrate embodiments of an integrated modular battery system 200. The battery system may include battery case 210, which is partitioned into cell compartment 211 and BMS compartment 212. The battery management compartment 212 may include BMS vents 213 to facilitate dissipation of heat built up in the battery case on account of the components of the BMS. In one embodiment, the system may be provided with air gaps or standoff around one or more sides (e.g., elevated 10-20 mm above solid surfaces) to ensure the BMS vents may effectively facilitate airflow.

The battery case may be closed on one side by removable lid 214 that contains one or more battery cells, BMS 220, or other components of the battery. The battery case may also include rear vent 215 to facilitate dissipation of heat related to the battery cells or permit air to flow through the entire battery case.

The BMS may include user electrical connection 221 and BMS display 222. While shown on the BMS, the electrical connection may potentially be located on or in any portion of the system as is beneficial for access in a particular application. In one embodiment, more than one electrical connection may be provided. The BMS display may be a series of bulbs or light emitting diodes (LEDs), or a display screen (e.g., liquid crystal display, cathode ray tube display, nano emissive display) to provide information about the system (e.g., charging, discharging, charge level, charge or discharge time, battery health, warnings, statistics).

The system may further include BMS auxiliary connection(s) 228. The BMS auxiliary connections may include additional power (e.g., source or sink) or communication/data transfer connections. In one embodiment, the auxiliary connections may facilitate additional connections for electrical power. In alternative or complementary embodiments, the auxiliary connections may allow the system to interface with a device (e.g., computer) to provide information (e.g., battery information) or receive information (e.g., new battery management firmware).

As may be seen in FIG. 2, the battery case may contain both the battery cells and BMS in a uniform, integral battery case. The BMS may be mounted flush into the battery case, providing a simple geometry for easy handling and damage resistance.

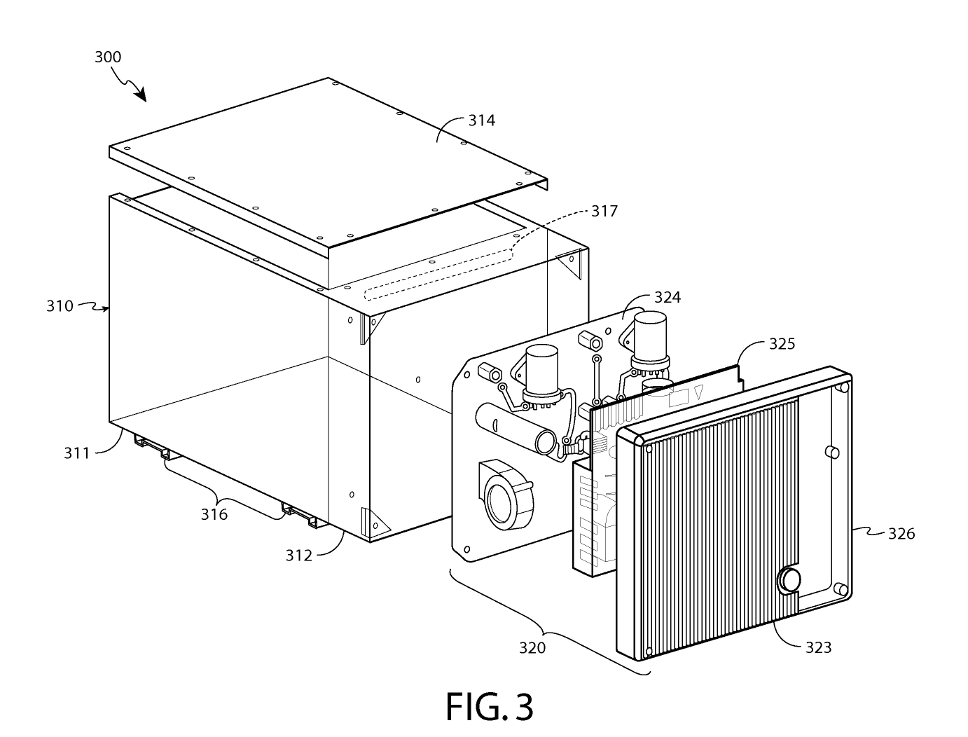

FIG. 3 illustrates an embodiment of a partially exploded view of a battery system 300 including an integrated BMS 320. The system may include battery case 310 which is partitioned into cell compartment 311 and BMS compartment 312 communicatively linked via feedthrough 317. The cell compartment may be enclosed at least in part by removable cell compartment lid 314. The battery case may additionally include storage adapter(s) 316 that may facilitate integration of the battery with various retention systems (e.g., racks, cases, rails, stacks).

The BMS may mount flush into the BMS compartment and may include multiple components. For example, BMS passive board 324 may be mounted closest to the cell compartment to facilitate connection of bus wires from the battery cells through the feedthrough. BMS logic board 325 may be connected to the BMS passive board. Finally, front plate 329 including BMS heat sink 323 may be affixed to the BMS compartment (and/or connections or extensions thereof) to retain and protect other components of the BMS. The front plate may be easily removable through movable or common connections (e.g., hinges, sliding portions, common fasteners, hand-tightened components). By placing the heat sink at an outward surface, heat may be effectively dissipated from within the system. In one embodiment, the BMS may be a single module including the passive board, the logic board, and the front plate (with or without the heat sink) that is installed and removed as a single component. In other embodiments, these components may be individually installed and removed. In still alternative or complementary embodiments, sub-components (e.g., resistors, capacitors, wires of the BMS passive board; chips or memory of the BMS logic board; and power connectors, data connectors, or portions of the heat sink of the front plate) of the BMS passive board, the BMS logic board, and/or the front plate may be individually added or withdrawn.

FIGS. 4A, 4B, and 4C illustrate embodiments of a multi-compartment integrated battery system 400. Different views of the system and its component serve to illustrate the relationship of different components within battery case 410 of the system. The battery case may have BMS 420 attached on one side.

For example, FIG. 4C shows a plurality 440 of battery cells 441 grouped for integration into cell case 430 as visible in FIG. 4B. The cell case is adapted for acceptance by cell compartment 411. In one embodiment, the cell case and the cell compartment have a pre-configured connection (e.g., socket or male-female connection) such that the cell case provides electrical communication between the plurality of battery cells immediately upon insertion. In alternative embodiments, an electrical connection may be manually configured after the cell case is placed into the cell compartment of the battery case.

The battery cells may be protected and contained in the cell case by cell case lid 431. The cell case lid may be removable to access individual cells or the plurality of cells in one or more groups. The cell case is similarly retained and protected by removable lid 414.

FIG. 4A shows the combination of components in the system, including the cell case surrounded by insulated panels 432 and 434-437. The cell case may include handling features 494. When battery cells and the BMS are integrated into the system, the system may become heavy, and with its uniform geometry may be difficult to move. Accordingly, the handling features may provide accessible points from which the battery may be manipulated.

In the system of FIG. 4, the BMS is not integrated for a flush fit into the battery case. Rather, the BMS is connected to the battery case via BMS mechanical connector(s) 418. The BMS mechanical connectors may be, for example, one or more fastener configurations designed to allow fasteners to connect the BMS to the battery case in accordance with the BMS geometry. The BMS and other portions of the battery may establish one or more electrical connections via BMS electrical connector 419 (not visible). The BMS electrical connector may include a plug or socket that allows a quick attach/detach connection of a BMS. Alternatively, the BMS electrical connector may include a feedthrough and one or more wires or other connectors for manual configuration. Other complementary and hybrid embodiments are embraced under the disclosures herein. The BMS may also include one or more user electrical connections 421 to allow users or other systems to connect to and utilize the batteries with external systems.

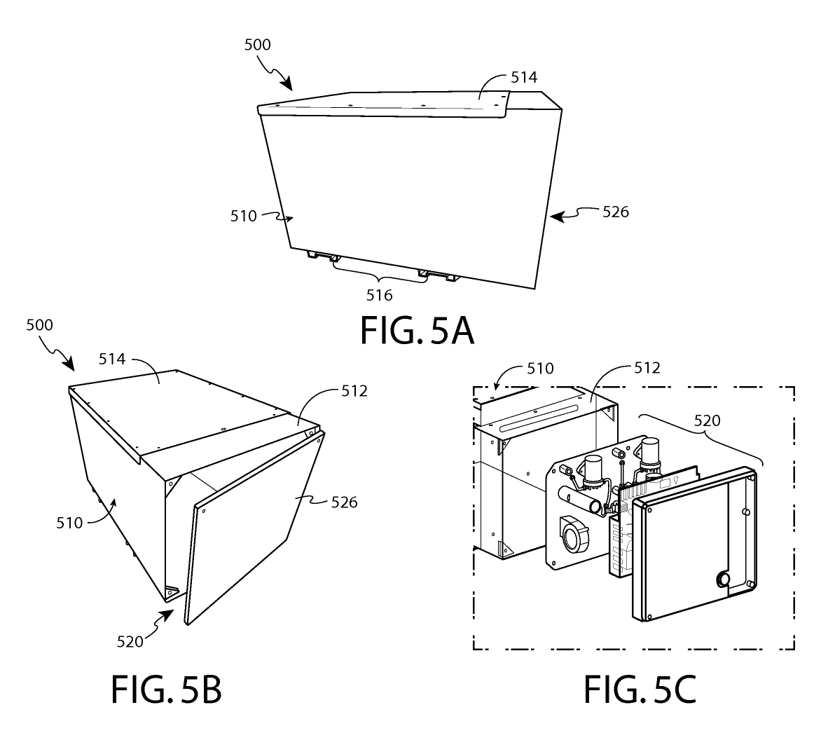

FIGS. 5A, 5B, and 5C illustrate embodiments of a battery system 500 including integral closing compartments for a battery cell module and a battery management system (BMS) module. The system may include battery case 510, which may be partitioned into a cell-containing portion and BMS containing portion 512. In one embodiment, the battery case may substantially be formed from a single portion of material, and the cell containing portion and BMS containing portion are not easily distinguished from visual inspection at particular angles (e.g., no mechanical connections or disconnections between portions).

BMS 520 may be integrated into the battery case and retained using BMS cover 526. In one embodiment, the BMS cover may be hinged, latched, or attached using hand-tightened or commonly available fasteners to facilitate simple installation or removal. A cell compartment lid may be used to retain and/or access one or more battery cells within the battery case.

The battery case may further include storage adapters 516 on one or more sides of the system.

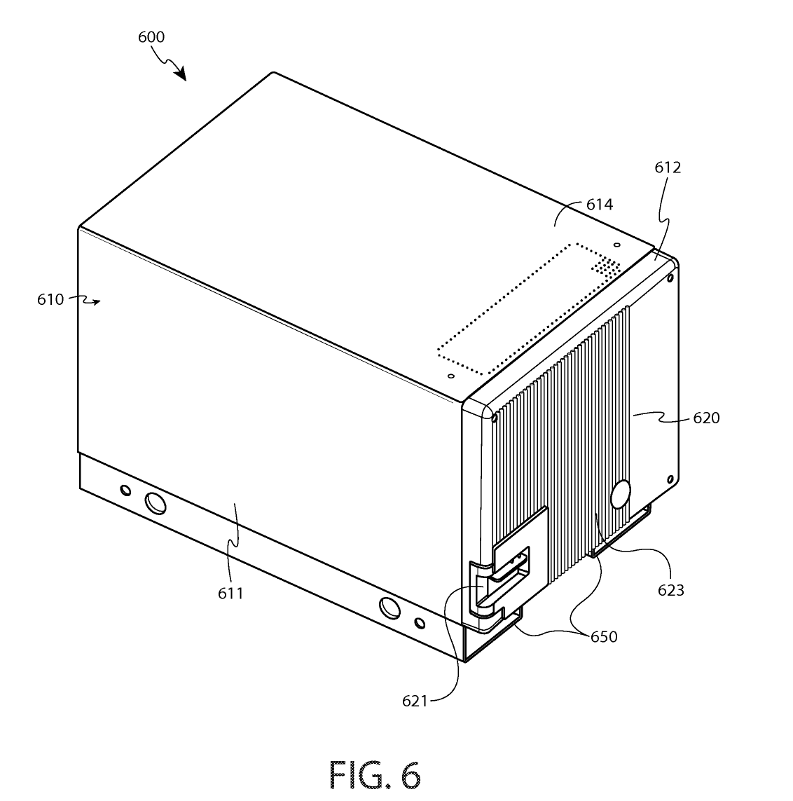

FIG. 6 illustrates an embodiment of an integrated battery system 600. The system includes battery case 610, which is partitioned into cell compartment 611 and BMS compartment (and/or front plate) 612. Integrated into the BMS compartment may be user electrical connection 621 and BMS heat sink 623, which may include a plurality of cooling fins or alternative geometry for exposing greater surface areas and/or facilitating flow-through of air.

The system may further include transport adapters 650 that may serve a purpose similar to storage adapters and/or permit the attachment of one or more transportation aids (e.g., forklift or board adapters, holes accepting hooks or rods) that may be configured through one or more geometries according to how and where the system may be moved.

FIGS. 7A and 7B illustrate embodiments of components included in an integral BMS 720. A battery system 700 may include BMS compartment 712 that retains the BMS.

The BMS may include BMS passive components 724. The BMS passive components may exist integrally within the BMS, on a board that comprises a portion of the BMS, or be configured for separate attachment (e.g., to the battery case) while still operating with the BMS.

The battery and/or constituent BMS may include bus connections 727 which traverse a partition between the BMS compartment and a cell compartment to provide a robust link between the power source and the BMS. FIG. 7B shows the bus connections in greater detail. The bus connections include bus wires 764 providing a conductive length between the interconnects 761A (positive terminal) and 761B (negative terminal). The bus wires may be a nickel conductor bus wire surrounded by high temperature electrical insulation. In alternative or complementary embodiments, bus wires can be constructed at least in part using nickel-plated copper or other materials having high electrical conductivity. The bus wires may be connected to the interconnects at least in part using ferrules 762A and 762B. The ferrules may be crimped. In one embodiment, the ferrules may also include welds 763A and 763B to provide additional security between the ferrule, the bus wires, and/or the interconnects. In embodiments, the ferrules can be formed of one or more of nickel, stainless steel, mild steel, and/or other suitable materials. In embodiments, the bus wires and/or ferrules can be constructed at least in part of materials resistant to corrosion.

The bus wires can be designed to be at least partially flexible. In one embodiment, the entire length of a bus wire can be flexible (e.g., the wires and insulation are flexible). In one embodiment, a portion of the bus wire can be flexible (e.g., one or more flexible points or portions of length).

The bus wires can be attached to the BMS, a battery terminal, or other portions in a variety of fashions. Bus wires, leads thereof, and/or interconnects can be crimped, welded, attached with adhesives or fasteners, and so forth. In one embodiment, combinations of multiple methods can be employed (e.g., crimped and welded).

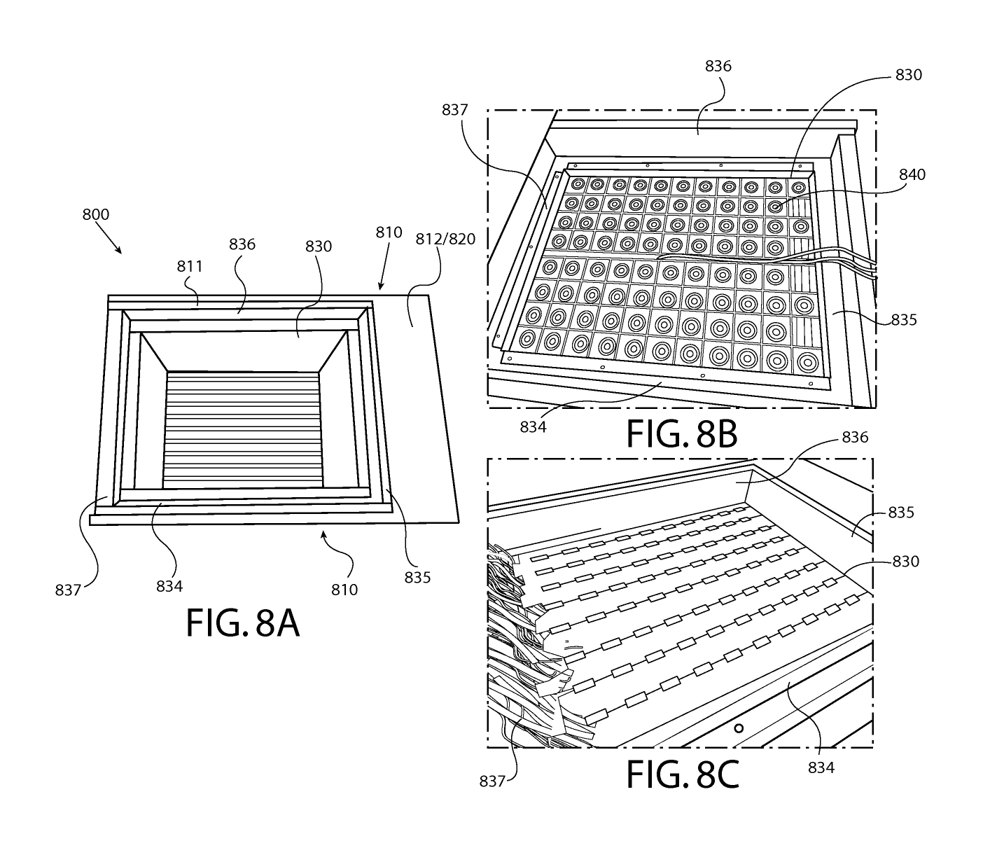

FIGS. 8A, 8B, and 8C illustrate perspectives of example embodiments of at least an integral battery cell compartment 811. The battery cell compartment may be a part of a larger battery system 800. The battery cell compartment may house battery cells 840 within cell case 830. The cell case may be surrounded at least by insulating panels 834-837. The system may further include BMS compartment 812 and BMS 820 that are at least partially partitioned from the cell compartment.

Various optional features may be included in embodiments herein. For example, in one embodiment such as that shown in FIG. 8A, the battery cell compartment or other portions of the battery case may include a sump plate. FIG. 8B depicts the employment of protective slats (e.g., mica). FIG. 8B illustrates an embodiment showing how individual cells may be inspected and removed without disassembly of the battery.

Embodiments of batteries may also include heaters, heater assemblies, or conductive plates for transmitting energy from a heater. Various battery cells may have optimal operating temperatures or bands of temperatures that provide different characteristics. Accordingly, various heating elements may be integrated to heat the cells to a particular operating temperature or temperature range to accommodate such configurations.

While particular combinations of aspects are shown in the figures, those skilled in the art will appreciate that various combinations and permutations of such aspects may be utilized in particular embodiments without the express description of each and every such embodiment herein.

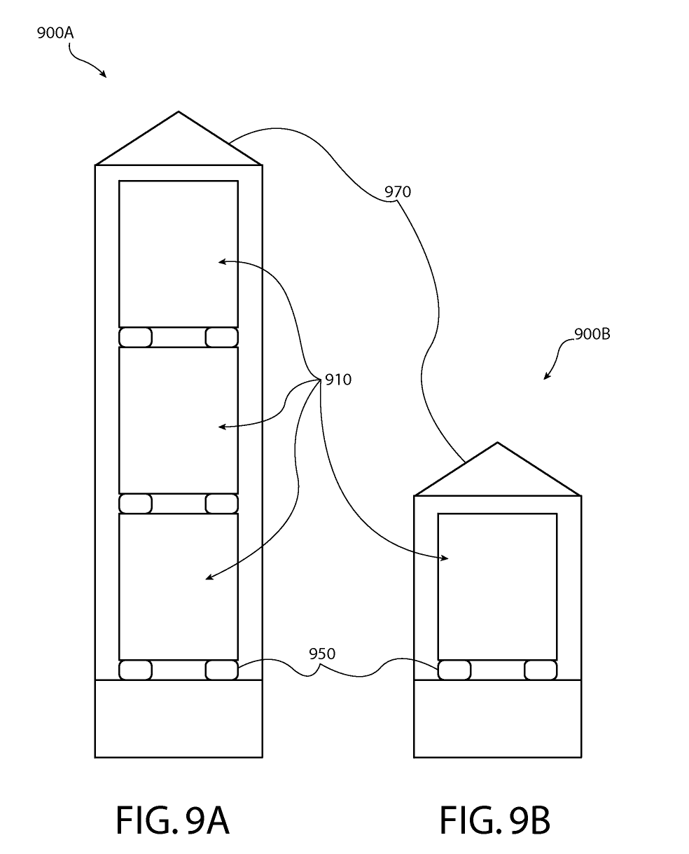

FIGS. 9A and 9B illustrate embodiments of techniques for utilizing batteries herein in varying environments. Systems 900A and 900B demonstrate multi- and single-battery applications where one or more batteries 910 are protected from a surrounding environment at least using elemental barrier 970. The batteries may include storage adapters 950 that at least partially elevate a battery above a surface and/or facilitate their stability or stacking. In one embodiment, a lower surface may be provided (e.g., to raise the battery above the earth or a water level) in addition to the at least partially surrounding environmental barrier. In one embodiment, environmental barriers may protect batteries from water, wind, extreme temperatures, direct sunlight, or other hazards that may interrupt or degrade battery performance.

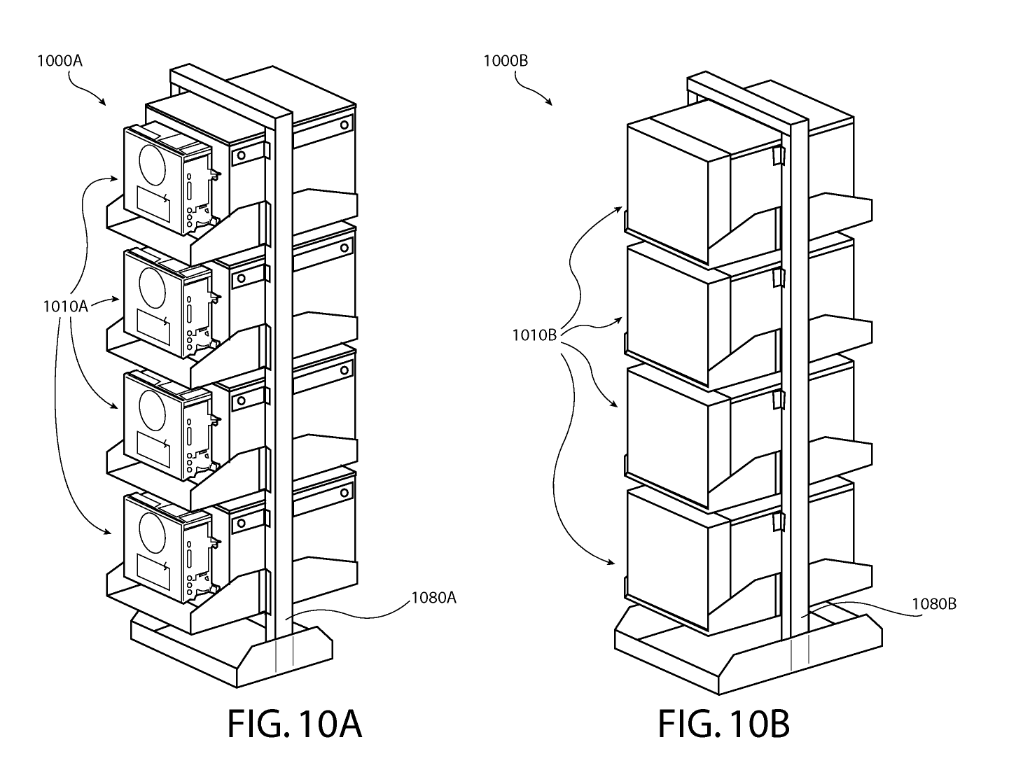

FIGS. 10A and 10B illustrate embodiments of techniques for storing and utilizing batteries disclosed. In one embodiment, systems 1000A and 1000B include battery storage apparatus(es) 1080A and 1080B to facilitate stacking and retention of batteries 1010A and/or 1010B. As may be seen, batteries 1010A include an external BMS, while batteries 1010B include an internal BMS. In various embodiments, different batteries may require different storage apparatuses or different trays within storage apparatuses. In alternative embodiments, different battery configurations may be accepted by the same storage apparatus. By stacking batteries, the batteries may be placed into a secure position, raised above ground level, and arranged to minimize a surface area footprint.

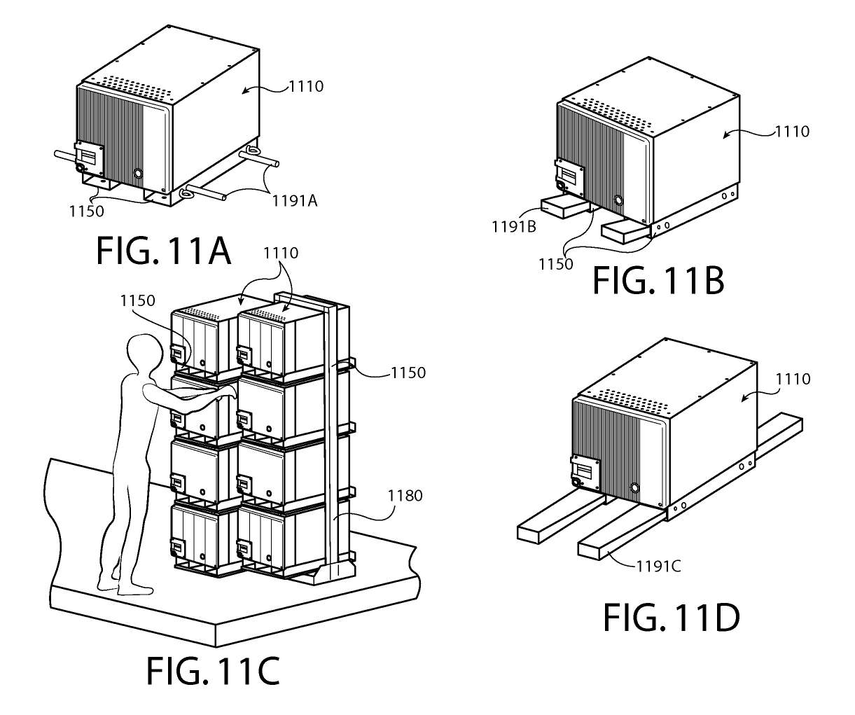

FIGS. 11A, 11B, 11C, and 11D illustrate embodiments for handling batteries disclosed. As may be seen, battery 1110 may have handling adapter(s) 1150 (e.g., forklift channel, other channel, carry handle, eyelet, attachment point, hole) designed to accept one or more handling aids 1191A, 1191B, and/or 1191C. For example, handling aid 1191A may be one or more rods inserted through one or more handling adapters perpendicular to a length of the battery (or another access direction for handling). FIG. 11A also shows eyelets, not presently in use, as a portion of or connected to the handling adapters. Such eyelets, or other holes in the handling adapters, may accept hooks, ropes, wires, and alternative handling aids (not pictured). Handling aid 1191B may be forklift forks to facilitate a forklift carry. Similarly, handling aid 1191C may be one or more boards placed through handling adapters 1150 to facilitate manual carrying by multiple persons. FIG. 11D shows both a rack access and stacked arrangement of the batteries.

In one embodiment, the handling options of a battery can be reconfigurable. Various handling mechanisms can be adjusted, moved, disconnected, attached, and so forth, to facilitate compatibility with multiple handling options. For example, eyelets or forklifts adapters can be added or removed. In one embodiment, one handling adapter can be removed to facilitate easier use of another.

In one embodiment, the handling features can be attached to an outermost case of a battery. In embodiments, the handling features can attach to or through multiple case layers.

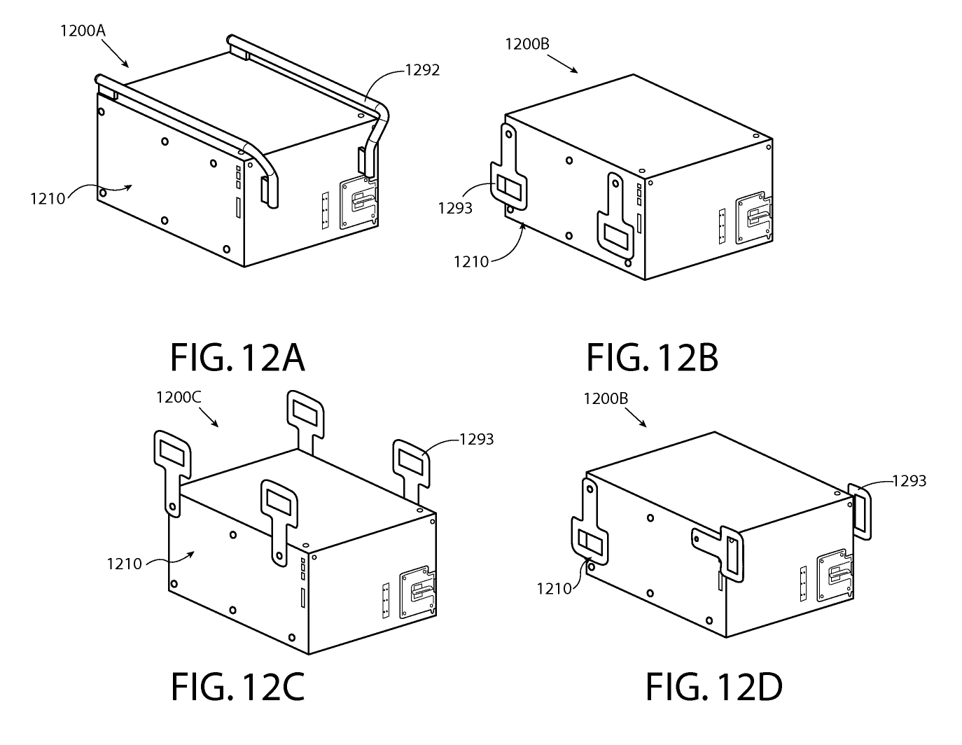

FIGS. 12A, 12B, 12C, and 12D illustrate embodiments of handling hardware for batteries disclosed. System 1200 may include battery 1210 with various handling hardware attached. Such handling hardware may include handles 1292 that facilitate an overhead carry or various other tied, threaded, or inserted handling aids to move or manipulate the battery. FIGS. 12B, 12C, and 12D show grips 1293 in various configurations. In one embodiment, the grips may be mounted to rotate through one or more degrees of freedom, and may be constrained at points in the rotation. Alternatively, the grips may rotate freely in any direction (e.g., using a ball joint) such that they are only constrained by coming into contact with the battery. The grips may be stowed or laid flat when not in use. In one embodiment, the grips (and/or handles and other handling adapters) may be removed when the battery is placed or not being moved.

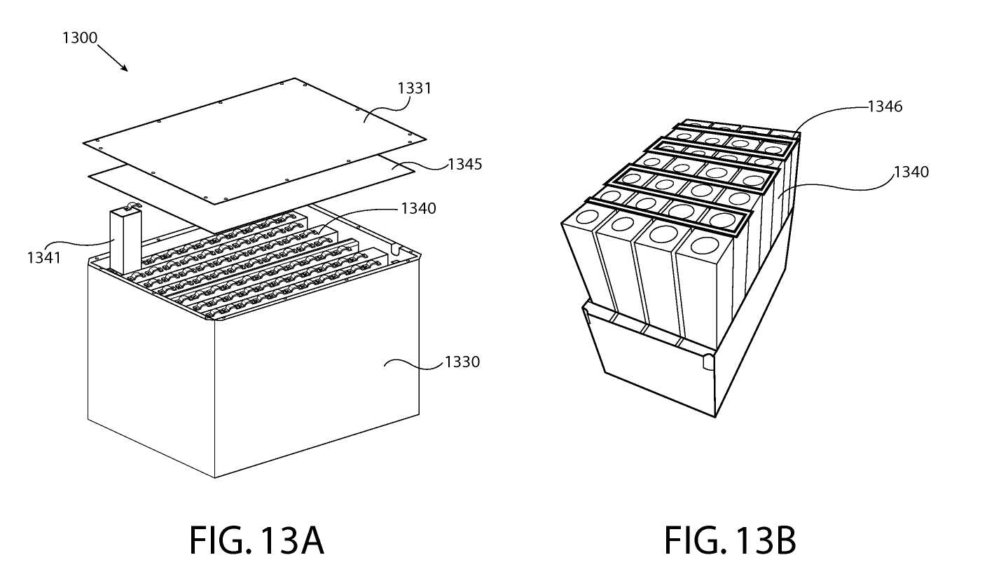

FIGS. 13A and 13B illustrate embodiments of a system 1300 for maintaining a consistent temperature gradient across a plurality of battery cells. The system may include a cell case 1330. In one embodiment, the cell case may be inserted into a modular battery. The cell case may contain a plurality 1340 of cells 1341. The cells may be retained and protected within the cell case using cell case lid 1331.

One or more sides of the plurality of cells may be lined by thermal plate 1345 as in FIG. 13A. The thermal plate may span two or more cells to facilitate heat exchange between and in the areas around the cells to facilitate a uniform temperature between the cells.

In alternative or complementary embodiments as pictured in FIG. 13B, a thermal serpentine 1346 may travel in the space between the plurality of cells. The thermal serpentine may facilitate heat exchange between and in the areas around the cells to facilitate a uniform temperature between the cells.

In practice, a battery can include areas of higher temperature relative to other areas of the battery. Thermal plates and/or thermal serpentines can be used to regulate a temperature gradient and attempt to reduce the gradient by conducting thermal energy throughout the battery to equalize the temperature in all areas. For example, a battery can have a first battery sector (e.g., a battery cell in a first corner of a battery cell case, a BMS compartment) and a second battery sector (e.g., a battery cell in a second corner of a battery cell case, a cell compartment). A thermal serpentine or thermal plate can be employed to encourage equalization of temperature or thermal load in the first battery sector and the second battery sector. In one embodiment, such an apparatus or component may be referred to as a “thermal spreader.”

Thermal spreaders may be made of one or more materials having high thermal conductivity and stability at high temperatures (e.g., above 400 degrees Celsius). Such materials can include metals, carbon-based materials, and others. In particular embodiments, thermal spreaders may be made of one or more of copper, aluminum, mild steel, and/or other metals. In embodiments employing copper, aluminum, and/or other particular materials, an anti-corrosion layer can be included (e.g., electroless or electroplated nickel coating for copper, anodized layer for aluminum).

Alternatively, such techniques may be integrated into existing batteries, non-modular batteries, non-rechargeable batteries, and others not disclosed or described in detail herein. For example, a thermal plate or thermal serpentine may be integrated into, for example, a conventional battery that is disposed upon discharge, or that does not permit the removal of cells or a BMS. Thermal plates and/or thermal serpentines can be integrated with any type of battery, and other non-battery innovations, without conflicting with other disclosures herein.

An embodiment relates to a high temperature battery comprising an inner case configured to contain one or more battery cells, at least one cell electrical connector configured to place the one or more battery cells in electrical communication, a two-compartment outer case, and an electrical interface assembly (e.g., the one or more battery cells may operate, in regards to cell energy storage chemistry, at or above 150° C.). The two-compartment outer case comprises a first compartment configured to contain at least the inner case, and a second compartment configured to contain at least a battery management system. The electrical interface assembly includes at least one bus wire configured to provide at least one connection for electrical communication between the first compartment and the second compartment. In an embodiment, the high temperature battery has a volume of at least 0.06 m³ (e.g., 400 mm by 400 mm by 400 mm) In another embodiment, the high temperature battery has a volume of at least 0.1 m³ (e.g., 500 mm by 500 mm by 400 mm)

Another embodiment relates to an assembly for enclosing a high temperature battery system. The assembly comprises a substantially cuboid cell retaining portion configured to accept a plurality of electrochemical storage cells, wherein the cell retaining portion is configured to open and close via at least a movable portion of a wall of the cell retaining portion. (For example, the electrochemical storage cells may operate, in regards to cell energy storage chemistry, at or above 150° C.) The assembly further comprises a battery management system retaining portion configured to accept a battery management system, wherein the battery management system retaining portion is dimensionally similar to the cell retaining portion in at least two dimensions. The assembly further comprises an electrical interface assembly configured to establish electrical communication between the cell retaining portion and the battery management system retaining portion, and an outer shell portion that is configured to enclose at least the cell retaining portion and the battery management system retaining portion. In an embodiment, the assembly has a volume of at least 0.06 m³ (e.g., 400 mm by 400 mm by 400 mm) In another embodiment, the assembly has a volume of at least 0.1 m³ (e.g., 500 mm by 500 mm by 400 mm)

In another embodiment, a high temperature multi-cell battery comprises an inner case configured to contain one or more battery cells, a two-compartment outer case, at least one fiberglass-core vacuum insulating panel, and an electrical interface assembly (e.g., the one or more battery cells may operate, in regards to cell energy storage chemistry, at or above 150° C.). The two-compartment outer case comprises a first compartment configured to contain at least the inner case, and a second compartment configured to contain at least a battery management system. The at least one fiberglass-core vacuum insulating panel is between the inner case and the two-compartment outer case spanning at least one face of the inner case. The electrical interface assembly includes at least a first high-temperature insulated flexible bus wire and a second high-temperature insulated flexible bus wire configured to provide at least one connection for electrical communication between the first compartment and the second compartment, wherein the first high-temperature insulated flexible bus wire is configured to be connected to a positive electrical terminal associated with the one or more battery cells, and wherein the second high-temperature insulated flexible bus wire is configured to be connected to a negative electrical terminal associated with the one or more battery cells. In an embodiment, the high temperature multi-cell battery has a volume of at least 0.06 m³ (e.g., 400 mm by 400 mm by 400 mm) In another embodiment, the high temperature multi-cell battery has a volume of at least 0.1 m³ (e.g., 500 mm by 500 mm by 400 mm)

While various particular embodiments are described, it is appreciated that, unless expressly stated otherwise, the embodiments and details relating thereto are non-exclusive, non-exhaustive, and may be used in conjunction with other aspects herein without departing from the scope or spirit of the disclosure.

With reference to the drawings, like reference numerals designate identical or corresponding parts throughout the several views. However, the inclusion of like elements in different views does not mean a given embodiment necessarily includes such elements or that all embodiments of the innovation include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity may be expected, while in other circumstances the event or capacity may not occur—this distinction is captured by the terms “may” and “may be”.

The terms “including” and “having” are used as the plain language equivalents of the term “comprising”; the term “in which” is equivalent to “wherein.” Moreover, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present innovation are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims. In addition, references to “one embodiment” do not prevent aspects described from being included in other possible embodiments.

This written description uses examples to disclose the innovation, including the best mode, and also to enable one of ordinary skill in the art to practice the innovation, including making and using any devices or systems and performing any incorporated methods. The embodiments described herein are examples of articles, systems, and methods having elements corresponding to the elements of the innovation recited in the claims. This written description may enable those of ordinary skill in the art to make and use embodiments having alternative elements that likewise correspond to the elements of the innovation recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. A high temperature battery, comprising:
an inner case configured to contain one or more battery cells;
at least one cell electrical connector configured to place the one or more battery cells in electrical communication;
a two-compartment outer case, comprising:
a first compartment configured to contain at least the inner case; and
a second compartment configured to contain at least a battery management system; and
an electrical interface assembly including at least one bus wire configured to provide at least one connection for electrical communication between the first compartment and the second compartment.

2. The battery of claim 1, further comprising at least one insulating panel between the inner case and the two-compartment outer case spanning at least one face of the inner case.

3. The battery of claim 2, wherein the at least one insulating panel is a fiberglass-core vacuum insulation panel.

4. The battery of claim 1, wherein the at least one bus wire is thermally insulated along a length of a wire portion.

5. The battery of claim 1, wherein the at least one bus wire is flexible along a length of a wire portion.

6. The battery of claim 1, wherein the at least one bus wire includes at least one contact configured to connect the at least one bus wire to the battery management system.

7. The battery of claim 6, wherein the at least one contact includes at least one ferrule.

8. The battery of claim 1, wherein the at least one bus wire includes at least a first bus wire and a second bus wire, wherein the first bus wire is configured to be connected to a positive electrical terminal associated with the one or more battery cells, and wherein the second bus wire is configured to be connected to a negative electrical terminal associated with the one or more battery cells.

9. The battery of claim 8, wherein a wire portion of the at least one bus wire is crimped and welded to at least one contact.

10. The battery of claim 1, wherein the at least one bus wire is crimped and welded to an electrical terminal associated with the one or more battery cells.

11. The battery of claim 1, further comprising a removable inner lid of the inner case configured to provide access to at least the one or more battery cells.

12. The battery of claim 1, further comprising a removable outer lid of the two-compartment outer case configured to provide access to at least one of the first compartment or the second compartment.

13. The battery of claim 1, further comprising:
a passive component board of the battery management system; and
one of more contacts on the passive component board configured to connect the at least one bus wire to the battery management system.

14. The battery of claim 1, further comprising a logic board of the battery management system.

15. The battery of claim 1, further comprising a battery management system heat sink.

16. An assembly for enclosing a high temperature battery system, the assembly comprising:
a substantially cuboid cell retaining portion configured to accept a plurality of electrochemical storage cells, wherein the cell retaining portion is configured to open and close via at least a movable portion of a wall of the cell retaining portion;
a battery management system retaining portion configured to accept a battery management system, wherein the battery management system retaining portion is dimensionally similar to the cell retaining portion in at least two dimensions;
an electrical interface assembly configured to establish electrical communication between the cell retaining portion and the battery management system retaining portion; and
an outer shell portion configured to enclose at least the cell retaining portion and the battery management system retaining portion.

17. The assembly of claim 16, wherein the outer shell portion is re-configurable between at least two handling configurations.

18. The assembly of claim 16, further comprising at least one handling adapter connected to the outer shell portion.

19. The assembly of claim 18, wherein the handling adapter includes at least one of a forklift channel, a carry handle, or a channel that accepts a beam to support a weight of the assembly.

20. The assembly of claim 16, further comprising a thermal spreader configured to transfer heat between a first battery sector and a second battery sector.

21. The assembly of claim 20, further comprising two or more electrochemical storage cells within the cell retaining portion, wherein the thermal spreader is constructed, at least in part, in a serpentine configuration that travels between the two or more electrochemical storage cells.

22. The assembly of claim 20, further comprising two or more electrochemical storage cells within the cell retaining portion, wherein the thermal spreader is constructed, at least in part, in a plane configuration that spans corresponding sides of the two or more electrochemical storage cells.

23. A high temperature multi-cell battery, comprising:
an inner case configured to contain one or more battery cells;
a two-compartment outer case, comprising:
a first compartment configured to contain at least the inner case, and
a second compartment configured to contain at least a battery management system;
at least one fiberglass-core vacuum insulating panel between the inner case and the two-compartment outer case spanning at least one face of the inner case; and
an electrical interface assembly including at least a first high-temperature insulated flexible bus wire and a second high-temperature insulated flexible bus wire configured to provide at least one connection for electrical communication between the first compartment and the second compartment, wherein the first high-temperature insulated flexible bus wire is configured to be connected to a positive electrical terminal associated with the one or more battery cells, and wherein the second high-temperature insulated flexible bus wire is configured to be connected to a negative electrical terminal associated with the one or more battery cells.
